(19) United States
(12) Patent Application Publication
(10) Pub. No.: US 2008/0291057 A1
(43) Pub. Date: Nov. 27, 2008

(54) Mobile Object Management System, Mobile Terminal and Processing Apparatus

(75) Inventors: Shugo Horikami, Kanagawa (JP); Isao Ogawa, Kanagawa (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/571,898

(22) PCT Filed: Jul. 13, 2004
(86) PCT No.: PCT/JP2004/010284

§ 371 Date: Jan. 10, 2007

(51) Int. Cl. G08G 1/13

(52) U.S. Cl. 340/995.1

(57) ABSTRACT

Watermark embedding embeds a digital watermark in positional information measured by positioner for measuring a current position of the mobile object. The positional information embedded with the digital watermark is outputted by a track information output as track information to a carrying medium. The track information is obtained by track information obtaining from the carrying medium, and detected by watermark detection whether water mark is embedded or not. The track information from which the digital watermark is detected and the track information from which no digital watermark is detected are displayed by track display in different modes.

### TECHNICAL FIELD OF THE INVENTION

The present invention relates to a mobile object management system, a mobile terminal, and a processing apparatus which can protect track information from being falsified.

### DESCRIPTION OF THE RELATED ART

A total travel distance of a mobile object such as a vehicle is important when the mobile object is sold or bought in the market, and therefore, required to be protected from being falsified. As one of mobile object management systems, which can prevent the total travel distance from being falsified, there is proposed an electric odometer for an automobile disclosed in Japanese Patent Laid Open Publication No. 2003-35559.

The electric odometer for an automobile disclosed herein writes both a total travel distance and a backup value calculated by being substituted the total travel distance into a predetermined function into an EEPROM which provides a nonvolatile storage, compares the total travel distance with a value calculated by being substituted the backup value into the inverse function of the predetermined function, and judges that that the total travel distance is falsified if the total travel distance is not matched with the value, for the purpose of protecting the total travel distance from being falsified.

Further, there is proposed a mobile object management system disclosed in Japanese Patent Laid Open Publication No. H05-62093 as comprising a mobile object equipped with positioning means for measuring a position of the mobile object. The mobile object management system disclosed herein detects the position of the mobile object in communication with the positioning means of the mobile object, compares the position of the mobile object with a target position stored in management information storing means, judges that the mobile object passes through the target position if the result of the comparison is matched, and store the positional information into information storage means at least in association with a transit time, thereby enabling to prevent any arbitrary data from entering into the mobile object management system.

The mobile object management system, however, encounters a drawback in that data cannot be protected completely from being falsified especially while the data is being carried because the data structure is simple.

As a medium for carrying data may be used a medium having installed therein a security function, i.e., a storage device complete with a security function, or a dedicated line, in order to protect the data from being falsified, but ending up with increase in economic burden.

The present invention is made with a view to overcoming the foregoing drawbacks, and it is an object of the present invention to provide a mobile object management system, a mobile terminal, and a processing apparatus which can protect data from being falsified while the data is being carried as well as are inexpensive in costs.

### DISCLOSURE OF THE INVENTION

According to a first aspect of the present invention, there is provided a mobile object management system, comprising a mobile terminal to be mounted on a mobile object and a processing apparatus to be coupled with the mobile terminal through a carrying medium, the mobile terminal including: positioning means for measuring positional information of the mobile object; watermark embedding means for embedding a digital watermark in the positional information measured by the positioning means; and track information outputting means for outputting the positional information embedded by the water mark embedding means with the digital watermark as track information to the carrying medium, and the processing apparatus including: track information obtaining means for obtaining the track information from the carrying medium, watermark detecting means for detecting the digital watermark embedded in the positional information obtained from the carrying medium, and track displaying means for displaying the track information from which the digital watermark is detected and the track information from which the digital watermark is not detected respectively in different modes.

The mobile object management system thus constructed as previously mentioned can protect data from being falsified while the data is being carried as well as are inexpensive in costs, resulting from the fact that the track information from which the digital watermark is detected and the track information from which the digital watermark is not detected are displayed respectively in different modes.

Further, in the mobile object management system according to the present invention, the processing apparatus may further include map information outputting means for updating so far retained map information based on the track information from which the digital watermark is detected, and outputting the updated map information to the carrying medium, and the mobile terminal may further include map information obtaining means for obtaining the map information from the carrying medium, and map information displaying means for displaying the map information obtained by the map information obtaining means.

The mobile object management system thus constructed as previously mentioned can have the mobile terminal display the updated map information with high reliability as well as maintain the reliability of the map, resulting from the fact that the map information is updated based on the track information having high reliability from among the track information transmitted from the mobile object, and the updated map information is inputted to the carrying medium.

In accordance with a second aspect of the present invention, there is provided a mobile terminal to be used for a mobile object management device, comprising positioning means for measuring positional information of the mobile object; watermark embedding means for embedding a digital watermark in the positional information measured by the positioning means; and track information outputting means for outputting the positional information embedded by the water mark embedding means with the digital watermark as track information to a carrying medium.

The mobile terminal thus constructed as previously mentioned can protect the track information from being falsified resulting from the fact that the positional information embedded by the water mark embedding means with the digital watermark is outputted as track information.

The mobile terminal to be used for a mobile object management device may further comprise map information obtaining means for obtaining map information from the carrying medium, and map information displaying means for displaying the map information obtained by the map information obtaining means.

The mobile terminal thus constructed as previously mentioned can have the mobile terminal display the latest map information, resulting from the fact that the map information is obtained through the carrying medium.

In accordance with a third aspect of the present invention, there is provided a processing apparatus to be used for a mobile object management comprising: track information obtaining means for obtaining track information from carrying medium, watermark detecting means for detecting a digital watermark embedded in the positional information obtained from the carrying medium, and track displaying means for displaying the track information from which the digital watermark is detected and the track information from which the digital watermark is not detected respectively in different modes.

The processing apparatus thus constructed as previously mentioned can discriminate falsified track information, resulting from the fact that the track information from which the digital watermark is detected and the track information from which the digital watermark is not detected are displayed respectively in different modes.

The processing apparatus to be used for a mobile object management may further comprise map information outputting means for updating so far retained map information based on the track information from which the digital watermark is detected, and outputting the updated map information to the carrying medium.

The processing apparatus thus constructed as previously mentioned can maintain the reliability of the map at a high level, resulting from the fact that the map information is updated based on the track information from which the digital watermark is detected, and outputting the updated map information.

### BRIEF DESCRIPTION OF THE DRAWINGS

The features and advantages of a mobile object management system, a mobile terminal, and a processing apparatus according to the present invention will be more clearly understood from the following detailed description when considered in connection with the accompanying drawings, in which

FIG. 1 is a block diagram showing a first preferred embodiment of a mobile object management system according to the present invention;

FIG. 2 is a map explaining an operation of the first embodiment of the mobile object management system;

FIG. 3 is a view explaining accurate positional information, positional information with digital watermark, and track information;

FIG. 4 is a view explaining added track information;

FIG. 5 is a view explaining falsified track information;

FIG. 6 is a block diagram showing a second preferred embodiment of a mobile object management system according to the present invention; and

FIG. 7 is a map explaining an operation of the second embodiment of the mobile object management system.

### DESCRIPTION OF THE PREFERRED EMBODIMENTS

The following description will be directed to a plurality of preferred embodiments according to the present invention with reference to the drawings.

### First Preferred Embodiment

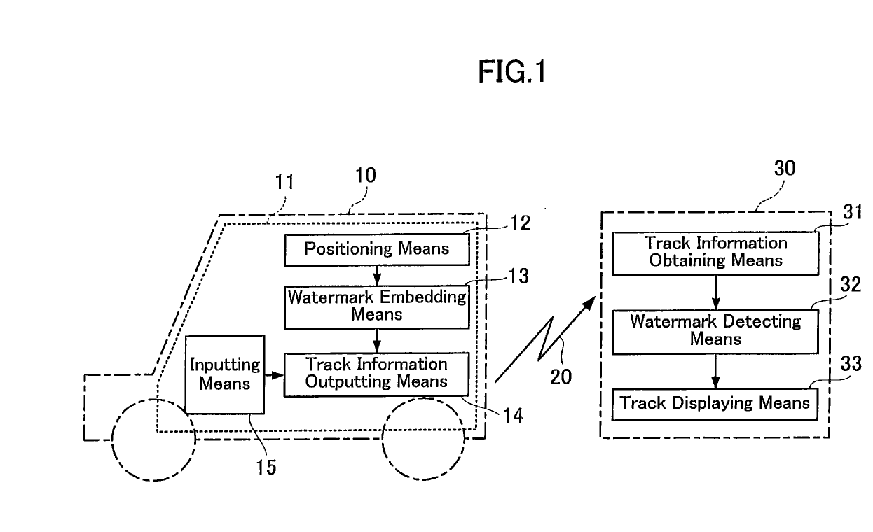

A first embodiment of the mobile object management system according to the present information is shown in FIG. 1 as comprising a mobile terminal 11 to be mounted on a mobile object 10 and a processing apparatus 30 to be coupled with the mobile terminal 11 through a carrying medium 20.

The mobile terminal 11 includes positioning means 12 for measuring current positional information of the mobile object 10, watermark embedding means 13 for embedding a digital watermark in the positional information measured by the positioning means 12; and track information outputting means 14 for outputting the positional information embedded by the watermark embedding means 13 with the digital watermark as track information to the carrying medium 20.

The processing apparatus 30 includes track information obtaining means 31 for obtaining the track information from the carrying medium 20, watermark detecting means 32 for detecting the digital watermark embedded in the positional information obtained from the carrying medium 20, and track displaying means 33 for displaying the track information from which the digital watermark is detected and the track information from which the digital watermark is not detected respectively in different modes.

The positioning means 12 is constituted by a GPS (Global Positioning System), for example. The carrying medium 20 is constituted by, for example, a wire communication line, a wireless communication line, and/or a storage medium such as a memory card, a magnetic disk, or the like. Here, it is to be noted that there is no need for the carrying medium 20 itself to be equipped with any falsification-proof function.

The mobile terminal 11 further comprises inputting means 15 constituted by, for example, a numeric keypad, connected with the track information outputting means 14, thereby making it possible for a driver of the mobile object 10 to input data therethrough.

The processing apparatus 30 may be installed in the mobile object 10 itself, or disposed in a place such as a processing center separated from the mobile object 10.

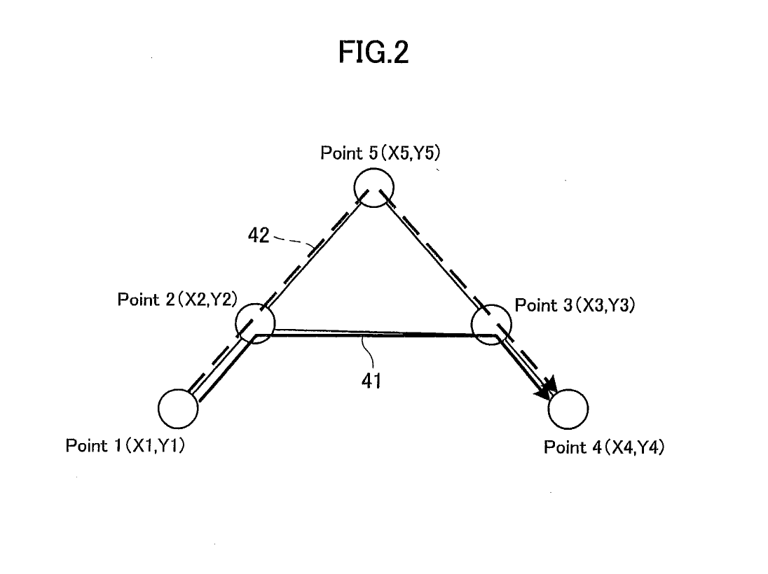

The description hereinlater will be directed to the operation of the present embodiment of the mobile object management system thus constructed with reference to FIG. 2, under the assumption that track information of the mobile object 10 is managed.

The track information is represented by lines connecting coordinates (latitude and longitude) of points, each of which the mobile object 10 passed through, in order of time of passage.

In FIG. 2, a full line 41 is intended to mean track information which the mobile object 10 actually passed through, and a dotted line 42 is intended to mean falsified track information.

Positional information of a point i includes latitude Xi and longitude Yi of the point i, and a time of passage Ti at which the mobile object 10 passed through the point i.

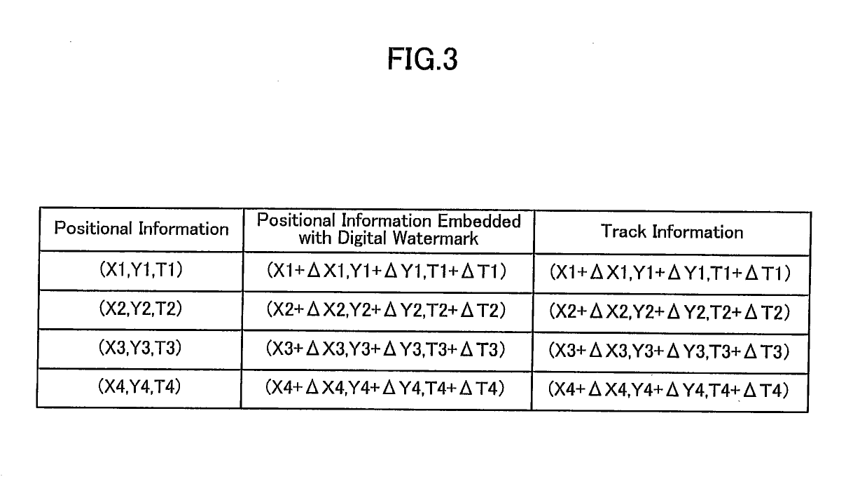

If the mobile object 10 is moved from a point 1 to a point 4 through a point 2 and a point 3, the positioning means 12 outputs positional information represented by a first column of a table shown in FIG. 3.

The watermark embedding means 13 embeds a digital watermark in the positional information thus measured.

This means that the watermark embedding means 13 superimposes a superimposition value (ΔXi, ΔYi, ΔTi), which is calculated based on the positional information (Xi, Yi, Ti), on the positional information (Xi, Yi, Ti), to generate the positional information embedded with the digital watermark as track information represented by a second column of the table shown in FIG. 3.

According to the present invention, it is needless to mention that the operation of embedding a digital watermark in the positional information is not limited to the above mentioned method. Any method can be used to embed a digital watermark in the positional information.

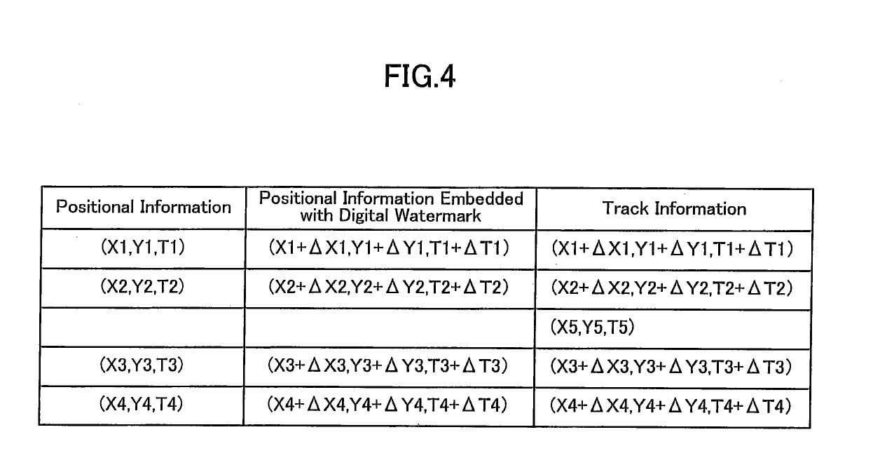

The positional information embedded with the digital watermark is then outputted by the track information outputting means 14 to the carrying medium 20, and carried by the carrying medium 20 as track information represented by a third column of the table shown in FIG. 4.

The track information is stored in the carrying medium 20 if the carrying medium 20 is constituted by a memory. The track information is transmitted through a communication line if the carrying medium 20 is constituted by a communication line.

When the track information is carried by the carrying medium 20 to the track information obtaining means 31 of the processing apparatus 30, the track information obtaining means 31 obtains the track information, the watermark detecting means 32 detects whether or not the digital watermark is embedded in the track information obtained from the carrying medium 20.

When it is detected that the digital watermark is embedded in the track information, it is judged that the track information is not falsified. The track displaying means 33 constituted by, for example, a liquid crystal panel, displays the track information.

Here, it is assumed that a driver operates the inputting means 15 and input data of point 5 through which the driver has not passed in order to falsify the track information as shown by dotted line 42 in FIG. 2.

As described hereinearlier, the inputting means 15 is connected with the track information outputting means 14, and thus, it is impossible to falsify the positional information outputted from the positioning means 12 using the inputting means 15. Accordingly, the track information on the point 5 (X5, Y5, T5) outputted from the track information outputting means 14 is not embedded with the digital watermark, as shown in FIG. 4.

This leads to the fact that it can be detected by the watermark detecting means 32 that the digital watermark is not embedded in the track information on the point 5 (X5, Y5, T5), and it can be judged that the track information on the point 5 (X5, Y5, T5) is falsified when the track information is processed in the processing apparatus 30.

Further, the track displaying means 33 can display the track information not falsified and the track information thus judged as being falsified respectively in different display modes, for example, different colors.

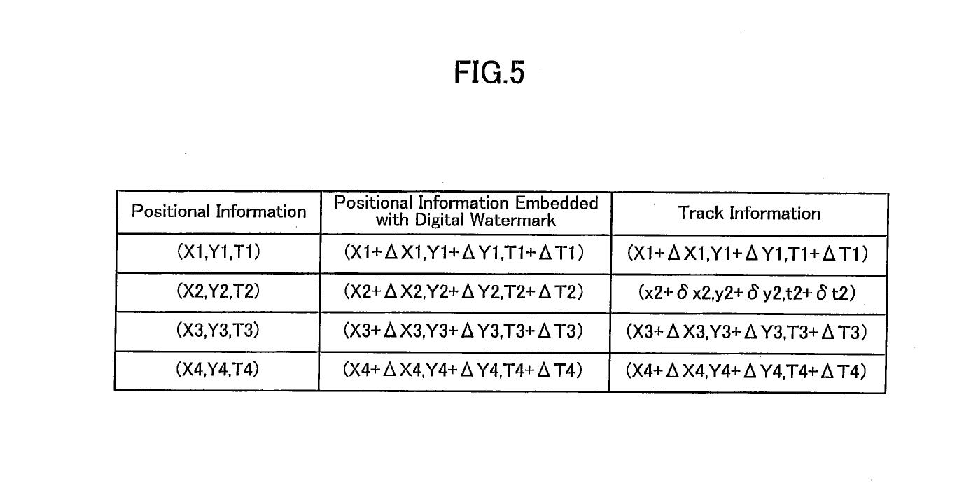

It is then assumed that the positional information embedded with the digital watermark, for example, the positional information on the point 2 (X2, Y2, T2) outputted from the watermark embedding means 13 is falsified to be, for example, the point 2 (x2, y2, t2), as shown in FIG. 5.

In this case, the falsified track information on the point 2 becomes (x2+δx2, y2+δy2, t2+δy2) because it is impossible to artificially embed a digital watermark, which is required to be calculated in accordance with a predetermined rule. The superimposition value (δx2, δy2, δy2) calculated based on the falsified positional information on the point 2 (x2, y2, t2), different from the superimposition value (ΔX2, ΔY2, ΔT2) calculated based on the positional information on the point 2 (X2, Y2, T2), is, therefore, superimposed on the falsified positional information on the point 2 (x2, y2, t2).

This leads to the fact that it can be detected by the watermark detecting means 32 that the digital watermark embedded by the watermark embedding means 13 is not present in the falsified track information on the point 2, and it can be judged that the track information on the point 2 is falsified.

Further, the positioning means 12 may measure positional information at predetermined time intervals, in order to prevent falsification of deleting the time information.

In the case that the positioning means 12 measures positional information on an irregular base, in order to prevent the falsification of deleting the time information, a serial number may be assigned to each piece of the positional information whenever the positional information is measured by the positioning means 12, and the serial number may be embedded with a digital watermark as well.

As will be appreciated from the foregoing description, it is to be understood that the present embodiment of the mobile object management system according to the present invention can display track information embedded with a digital watermark and track information not embedded with any digital watermark respectively in different modes, and thus easily discriminate falsification of the track information, resulting from the fact that the mobile terminal 11 includes watermark embedding means 13, and the processing apparatus 30 includes watermark detecting means 32.

### Second Preferred Embodiment

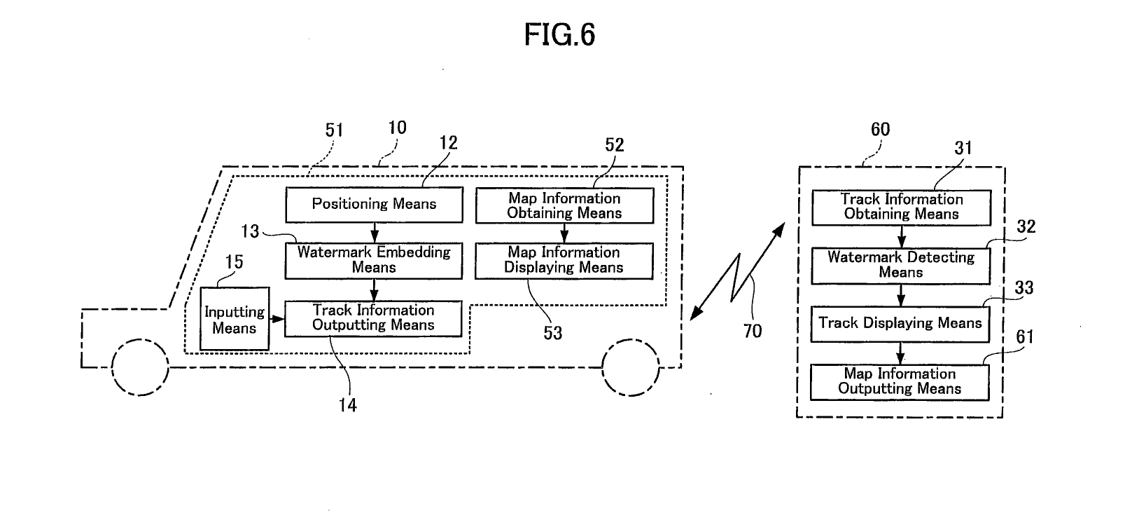

A second embodiment of the mobile object management system according to the present information is shown in FIG. 6 as comprising a mobile terminal 51 to be mounted on a mobile object 10 and a processing apparatus 60 to be coupled with the mobile terminal 51 through a carrying medium 70.

The mobile terminal 51 includes positioning means 12 for measuring a current position of the mobile object 10, watermark embedding means 13 for embedding a digital watermark in the positional information measured by the positioning means 12, track information outputting means 14 for outputting the positional information embedded by the watermark embedding means 13 with the digital watermark as track information to the carrying medium 70, map information obtaining means 52 for obtaining map information from the carrying medium 70, and map information displaying means 53 for displaying the map information obtained by the map information obtaining means 52.

The processing apparatus 60 includes track information obtaining means 31 for obtaining the track information from the carrying medium 70, watermark detecting means 32 for detecting the digital watermark embedded in the positional information obtained from the carrying medium 70, track displaying means 33 for displaying the track information from which the digital watermark is detected and the track information from which the digital watermark is not detected respectively in different modes, and map information outputting means 61 for updating so far retained map information based on the track information from which the digital watermark is detected by the watermark detecting means 32, and outputting the updated map information to the carrying medium 70.

In the present embodiment, the carrying medium 70 is constituted by a bi-directional wireless communication path. It is to be noted that there is no need for the carrying medium 70 itself to be equipped with any falsification-proof function.

This means that the carrying medium 70 does not need to be a dedicated line, and may be an Internet communication line.

In the present embodiment, the positional information measured by the positioning means 12 is transmitted to the processing apparatus 60 if the mobile object 10 passes through, for example, a newly built roadway.

In the processing apparatus 60, the map information outputting means 61 updates so far retained map information based on new information, and outputs the updated map information to the mobile terminal 51.

In the mobile terminal 51, the map information obtaining means 52 obtains the updated map information, and the map information displaying means 53 displays the updated map information.

The mobile terminal 51 thus constructed can constantly obtain the updated map information. It is therefore important to ensure the reliability of the positional information outputted from the mobile terminal 51, in order to maintain the reliability of the map.

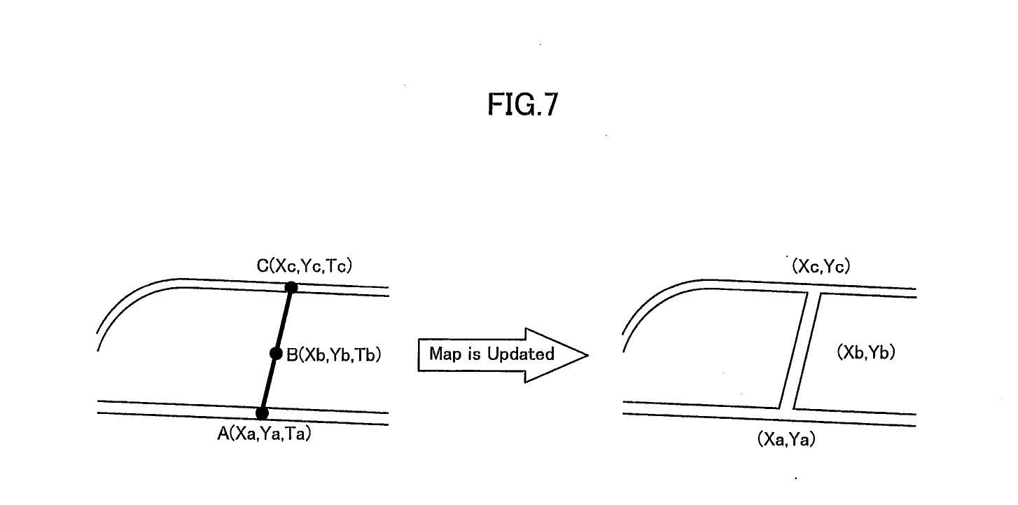

The description hereinlater will be directed to the operation of the present embodiment of the mobile object management system with reference to FIG. 7.

It is assumed that the mobile terminal 51, equipped with a positioning means 12 having a predetermined positioning accuracy, passes from, for example, an entrance point A (Xa, Ya) to an exit point C (Xc, Yc) through a middle point B (Xb, Yb) along a newly built roadway, and the positional information is measured by the positioning means 12 at respective points A, B, and C.

The watermark embedding means 13 embeds a digital watermark in the positional information, and the track information outputting means 14 outputs the track information to the processing apparatus 60.

In the processing apparatus 60, the watermark detecting means 32 detects whether or not the digital watermark is embedded in the track information transmitted from the mobile terminal 51 to ensure the reliability of the track information.

Then, the track displaying means 33 adds the roadway starting from the entrance point A (Xa, Ya) to the exit point C (Xc, Yc) through the middle point B (Xb, Yb) to the so far retained map information to have the map information updated. The map information outputting means 61 then transmit the updated map information to the mobile terminal 51.

If, on the other hand, the track information outputted from the mobile terminal 51 is not embedded with the digital watermark, it is judged that the track information is falsified. Accordingly, the processing apparatus 60 aborts a process of updating the map information to prevent the map information from being deteriorated in quality.

As will be appreciated from the foregoing description, it is to be understood that the present embodiment of the mobile object management system according to the present invention can have the mobile terminal 51 display the updated map information with high reliability, resulting from the fact that the processing apparatus 60 includes a map information outputting means 61 for updating so far retained map information based on the track information from which the digital watermark is detected by the watermark detecting means 32, and outputting the map information thus updated to the mobile terminal 51.

While it has been described in the present invention that one single mobile terminal 51 is provide with positioning means 12, watermark embedding means 13, track information outputting means 14, inputting means 15, map information obtaining means 52, and map information displaying means 53, this does not limit the present invention. According to the present invention, there may be provided two separate mobile terminals including a first mobile terminal provided with the mobile terminal positioning means 12, the watermark embedding means 13, the track information outputting means 14, and the inputting means 15, and a second mobile terminal provided with the mobile terminal and the map information obtaining means 52 and the map information displaying means 53.

Further, the first mobile terminal provided with the mobile terminal positioning means 12, the watermark embedding means 13, the track information outputting means 14, and the inputting means 15, and the second mobile terminal provided with the mobile terminal and the map information obtaining means 52 and the map information displaying means 53 may be mounted on respective separate mobile terminals.

As will be appreciated from the foregoing description, it is to be understood that the present invention can provide a mobile object management system which can protect data from being falsified while the data is being carried.

### INDUSTRIAL APPLICABILITY OF THE PRESENT INVENTION

As will be seen from the foregoing description, the mobile object management system according to the present invention is available as a system protects data from being falsified while the data is being carried.

What is claimed is:

1. A mobile object management system, comprising a mobile terminal to be mounted on a mobile object and a processing apparatus to be coupled with said mobile terminal through a carrying medium,
said mobile terminal including:
positioning means for measuring positional information of said mobile object;
watermark embedding means for embedding a digital watermark in said positional information measured by said positioning means; and
track information outputting means for outputting said positional information embedded by said water mark embedding means with said digital watermark as track information to said carrying medium, and
said processing apparatus including:
track information obtaining means for obtaining said track information from said carrying medium,
watermark detecting means for detecting said digital watermark embedded in said positional information obtained from said carrying medium, and
track displaying means for displaying said track information from which said digital watermark is detected and said track information from which said digital watermark is not detected respectively in different modes.

2. The mobile object management system as set forth in claim 1, in which
said processing apparatus further includes map information outputting means for updating so far retained map information based on said track information from which said digital watermark is detected, and outputting said updated map information to said carrying medium, and
said mobile terminal further includes map information obtaining means for obtaining said map information from said carrying medium, and map information displaying means for displaying said map information obtained by said map information obtaining means.

3. A mobile terminal, comprising
positioning means for measuring positional information of said mobile object;
watermark embedding means for embedding a digital watermark in said positional information measured by said positioning means; and
track information outputting means for outputting said positional information embedded by said water mark embedding means with said digital watermark as track information to a carrying medium.

4. The mobile terminal as set forth in claim 3, which further comprises
map information obtaining means for obtaining map information from said carrying medium, and
map information displaying means for displaying said map information obtained by said map information obtaining means.

5. The processing apparatus comprising:
track information obtaining means for obtaining track information from said carrying medium,
watermark detecting means for detecting a digital watermark embedded in said positional information obtained from said carrying medium, and
track displaying means for displaying said track information from which said digital watermark is detected and said track information from which said digital watermark is not detected respectively in different modes.

6. The processing apparatus as set forth in claim 5, which further comprises map information outputting means for updating so far retained map information based on said track information from which said digital watermark is detected, and outputting said updated map information to said carrying medium.
